(19) United States
(12) Patent Application Publication
(10) Pub. No.: US 2011/0232190 A1
(43) Pub. Date: Sep. 29, 2011

(54) HYDROPONIC SYSTEM FOR PROVIDING CONTROLLED ENVIRONMENT TO GROW PLANTS AND APPARATUS THEREFOR

(76) Inventors: Jeremy Pindus, Windsor (CA); Denis Buj, Windsor (CA)

(21) Appl. No.: 13/131,584

(22) PCT Filed: Nov. 26, 2009
(86) PCT No.: PCT/IB09/07727

§ 371 Date: May 26, 2011

Related U.S. Application Data
(60) Provisional application No. 61/118,018, filed on Nov. 26, 2008.

(51) Int. Cl. A01G 31/02

(52) U.S. Cl. 47/62 A; 47/62 R

(57) ABSTRACT

A hydroponic system for providing a controlled environment to grow plants comprises an apparatus for growing plants hydroponically. The apparatus comprises a container defining a roughly annular trough or cavity for holding nutrient fluid, and a plate member received on the container supporting a plurality of baskets holding root portions of plants therein such that the baskets are accommodated in the trough for communication with the nutrient fluid. The baskets are adapted to rotate about axes thereof A nutrient feeding mechanism comprises a feeding pump configured within a nutrient fluid storing reservoir tank and adapted to deliver nutrient fluid via a supply tube to the container. The apparatus comprises a light, a roof mounted on a support for supporting the container above a surface, and a plurality of door panels movably configured between the roof and the container. Air feeding means is provided to feed air to a chamber defined by the base, roof and doors.

### CROSS REFERENCE TO RELATED APPLICATIONS

The present application claims priority under 35 U.S.C. §119 on the United States Provisional Patent Application Ser. No. 61/118,018, filed on Nov. 26, 2008, the disclosure of which is incorporated by reference.

### FIELD OF THE DISCLOSURE

The present disclosure relates generally to horticulture equipments, and, more particularly, to a hydroponic system for providing a controlled environment to grow plants and an apparatus therefor.

### BACKGROUND OF THE DISCLOSURE

Recent developments in the field of horticulture have yielded new methods of growing plants. For example, hydroponics is one such method which includes growing plants without the help of soil. People may use hydroponics for indoor cultivation of fruits, vegetables, flowers, and ornamental plants as a hobby or as a professional activity. Various hydroponic systems are known in the art that utilize customized apparatuses for growing plants hydroponically by directly supplying nutrient fluid to root portions of the plants. Such hydroponic systems may utilize a nutrient feeding mechanism for supplying nutrient fluid to the root portions of the plants. In a typical hydroponic system, the nutrient feeding mechanism may be a container storing nutrient solution therein such that the root portions of the plants may be submerged in the nutrient solution for a hydroponic growth thereof.

Most of the hydroponic systems known in the art lack a proper nutrient feeding mechanism capable of appropriately feeding nutrient fluid to the root portions of the plants. For example, it is important that the delivery of the nutrient fluid to the root portions should neither exceed a required level, nor should the root portions be deprived of nutrient fluid. Accordingly, an appropriate nutrient feeding mechanism for delivering a controlled amount of nutrient fluid to the root portions of the plants is desirable.

Further, most of the customized apparatuses utilized in hydroponic systems known in the art are open configuration that lacks a cover arrangement for enclosing the plants. Use of such customized apparatuses may have adverse effects on the growth of the plant. More specifically, in the customized apparatuses, the plant foliage may be exposed to ambient light or noise while undergoing a dark reaction, thereby causing stress related effects on the growth of the plants. Accordingly, most of the customized apparatuses are not able to regulate the amount of light incident on the plant foliage. Furthermore, the customized apparatuses lack air regulating systems that are capable of providing fresh air for better growth of the plants. Moreover, the customized apparatuses know in the art are generally large in size, and accordingly, require more space for accommodation and involve high cost of manufacturing. Additionally, most of the customized apparatuses are immobile and are not aesthetically pleasing.

Accordingly, there exists a need for a hydroponic system for growing plants that is capable of providing a controlled amount of nutrient fluid to the plants and regulating the amount of light incident on the plants. Additionally, there exists a need for an apparatus for growing plants hydroponically that is adapted to be utilized in the hydroponic system for growing plants hydroponically such that the apparatus is compact in size, cost effective, mobile, aesthetically pleasing, and enables better growth of the plants.

### SUMMARY OF THE DISCLOSURE

In view of the foregoing disadvantages inherent in the prior art, the general purpose of the present disclosure is to provide a system for providing a controlled environment to grow plants and an apparatus therefor, which are configured to include all the advantages of the prior art, and to overcome the drawbacks inherent therein.

Accordingly, an object of the present disclosure is to provide a hydroponic system capable of providing a controlled environment to grow plants. Another object of the present disclosure is to provide an apparatus for growing plants hydroponically that is adapted to be utilized in the hydroponic system.

In light of the above objects, in one aspect of the present disclosure, a hydroponic system for providing a controlled environment to grow plants is disclosed. The system comprises an apparatus for growing plants hydroponically (herein after referred to an apparatus) and a nutrient feeding mechanism operatively coupled to the apparatus. The apparatus comprises a container, a support assembly, a plate member, a plurality of baskets, a roof assembly, a light assembly, and a plurality of door panels. The container comprises a base, a peripheral wall extending upwardly from a periphery of the base, and a hollow projecting member extending upwardly from a substantially central portion of the base. The hollow projecting member encloses a first cavity therewithin. The peripheral wall and the hollow projecting member enclose a second cavity therebetween. The second cavity is adapted to store a nutrient fluid therein. The support assembly supports the container above a surface. The plate member is received on the container for covering the first cavity and the second cavity. The plate member comprises a plurality of first slots configured thereon.

The plurality of baskets is received by the plurality of first slots of the plate member such that the plurality of baskets is supported on the base of the container and is accommodated in the second cavity of the container. The plurality of baskets is capable of holding root portions of the plants therein. Each of the plurality of baskets is adapted to rotate about an axis thereof. Further, each of the plurality of baskets is adapted to receive the nutrient fluid stored in the second cavity for growing the plants hydroponically. The roof assembly is mounted on the support assembly in a spaced apart relationship to the container to configure a hollow chamber between the roof assembly and the plate member received on the container. The light assembly is coupled to the roof assembly in a manner such that the light assembly is accommodated in the hollow chamber. The plurality of door panels is movably mounted between the roof assembly and the container. The plurality of door panels is adapted to be selectively moved for performing one of enclosing the hollow chamber therebetween and enabling an access to the hollow chamber.

The nutrient feeding mechanism comprises a nutrient reservoir tank, a nutrient feeding pump, and a nutrient supplying tube. The nutrient reservoir tank is capable of storing nutrient fluid therein. The nutrient feeding pump is configured within the nutrient reservoir tank. The nutrient supplying tube comprises a first end portion coupled to the nutrient feeding pump, and a second end portion mounted on the peripheral wall of the container. The nutrient feeding pump pumps the nutrient fluid into the nutrient supplying tube for delivering the nutrient fluid from the nutrient reservoir tank to the second cavity. A portion of the nutrient fluid is absorbed by the root portions of the plants received in the plurality of baskets.

In another aspect of the present disclosure, an apparatus for growing plants hydroponically is disclosed. The apparatus comprises a container, a support assembly, a plate member, a plurality of baskets, a roof assembly, a light assembly, and a plurality of door panels. The container comprises a base, a peripheral wall extending upwardly from a periphery of the base, and a hollow projecting member extending upwardly from a substantially central portion of the base. The hollow projecting member encloses a first cavity therewithin. The peripheral wall and the hollow projecting member enclose a second cavity therebetween. The second cavity is adapted to store a nutrient fluid therein. The support assembly supports the container above a surface. The plate member is received on the container for covering the first cavity and the second cavity. The plate member comprises a plurality of first slots configured thereon.

The plurality of baskets is received by the plurality of first slots of the plate member such that the plurality of baskets is supported on the base of the container and is accommodated in the second cavity of the container. The plurality of baskets is capable of holding root portions of the plants therein. Each of the plurality of baskets is adapted to rotate about an axis thereof. Further, each of the plurality of baskets is adapted to receive the nutrient fluid stored in the second cavity for growing the plants hydroponically. The roof assembly is mounted on the support assembly in a spaced apart relationship to the container to configure a hollow chamber between the roof assembly and the plate member received on the container. The light assembly is coupled to the roof assembly in a manner such that the light assembly is accommodated in the hollow chamber. The plurality of door panels is movably mounted between the roof assembly and the container. The plurality of door panels is adapted to be selectively moved for performing one of enclosing the hollow chamber therebetween and enabling an access to the hollow chamber.

These together with other aspects of the present disclosure, along with the various features of novelty that characterize the present disclosure, are pointed out with particularity in the claims annexed hereto and form a part of this present disclosure. For a better understanding of the present disclosure, its operating advantages, and the specific objects attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, in which:

FIG. 1A illustrates an exploded perspective view of a hydroponic system for providing a controlled environment to grow plants (herein after referred to as a hydroponic system), in accordance with an exemplary embodiment of the present disclosure;

FIG. 1B illustrates an assembled perspective view of the hydroponic system of FIG. 1A, in accordance with an exemplary embodiment of the present disclosure;

FIG. 2 illustrates an perspective view of a container utilized in the hydroponic system of FIG. 1A, in accordance with an exemplary embodiment of the present disclosure;

FIG. 3 illustrates a perspective view of a support assembly utilized in the hydroponic system of FIG. 1A, in accordance with an exemplary embodiment of the present disclosure;

FIG. 4 illustrates an unassembled perspective view of a plurality of baskets and a plate member utilized in the hydroponic system of FIG. 1A, in accordance with an exemplary embodiment of the present disclosure;

FIG. 5 illustrates an exploded perspective view of a driving assembly utilized in the hydroponic system of FIG. 1A, in accordance with an exemplary embodiment of the present disclosure;

FIG. 6 illustrates an arrangement between the plurality of baskets and the driving assembly, in accordance with an exemplary embodiment of the present disclosure;

FIG. 7 illustrates an exploded perspective view of a roof assembly utilized in the hydroponic system of FIG. 1A, in accordance with an exemplary embodiment of the present disclosure;

FIG. 8 illustrates a perspective view of a first set of tracks and the second set of tracks utilized in the hydroponic system of FIG. 1A, in accordance with an exemplary embodiment of the present disclosure;

FIG. 9 illustrates an exploded perspective view of a light assembly utilized in the hydroponic system of FIG. 1A, in accordance with an exemplary embodiment of the present disclosure; and

FIG. 10 illustrates a perspective view of the nutrient feeding mechanism of the hydroponic system of FIG. 1A, in accordance with an exemplary embodiment of the present disclosure.

Like reference numerals refer to like parts throughout the description of several views of the drawings.

### DETAILED DESCRIPTION OF THE DISCLOSURE

The exemplary embodiments described herein detail for illustrative purposes are subject to many variations in implementation thereof. It should be emphasized, however, that the present disclosure is not limited to a hydroponic system for growing plants in a controlled manner and an apparatus for growing plants hydroponically, as shown and described. It is understood that various omissions and substitutions of equivalents are contemplated as circumstances may suggest or render expedient, but these are intended to cover the application or implementation without departing from the spirit or scope of the claims of the present disclosure.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present disclosure provides a hydroponic system for providing a controlled environment to grow plants. The term ‘controlled environment’ used herein refers to an environment provided to the plants which enables in a uniform and a controlled growth of the plants. More specifically, the controlled environment, as used herein refers to regulating an amount of nutrient fluid being supplied to root portions of the plants for enabling proper hydroponic growth thereof. Moreover, the controlled environment includes regulation of ambient air, light, and temperature in the vicinity of the plants. Such controlled environment avoids various adverse and stress related effects on the plants' growth, thereby enabling better growth of the plants.

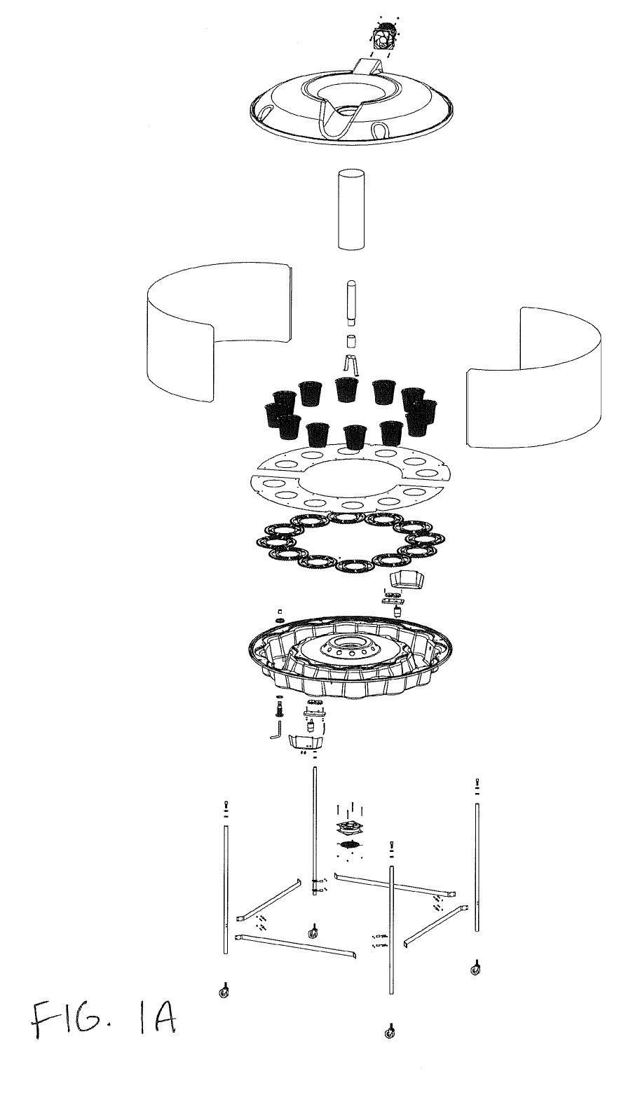

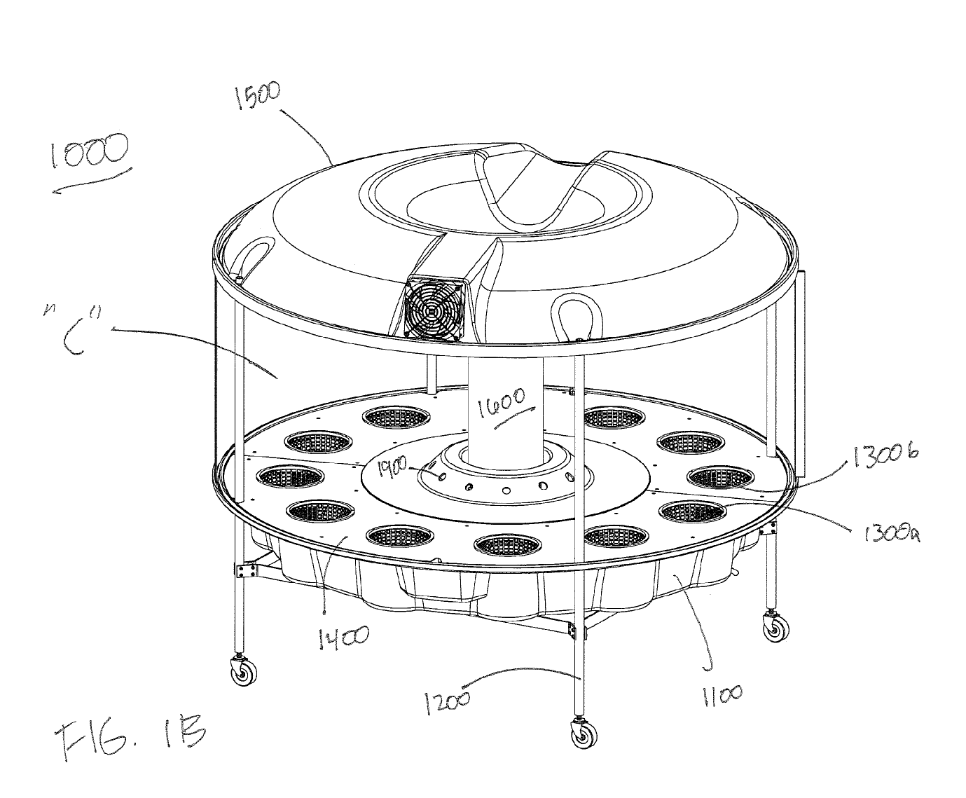

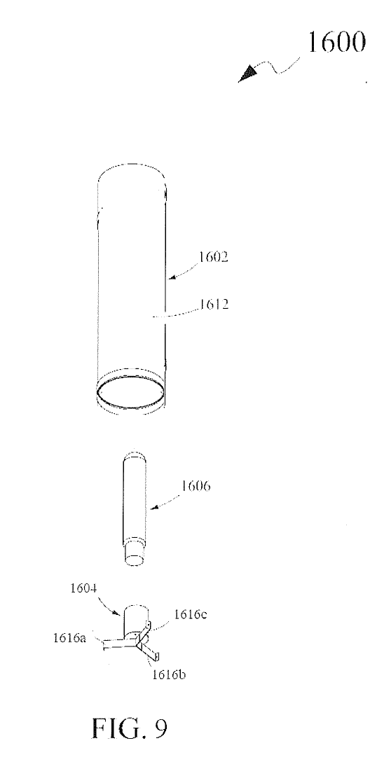

Referring to FIGS. 1A and 1B, a perspective view of the hydroponic system for providing the controlled environment to grow the plants, such as a hydroponic system 100, is illustrated, in accordance with an exemplary embodiment of the present disclosure. More specifically, FIG. 1A illustrates an exploded perspective view of the hydroponic system 100, in accordance with an exemplary embodiment of the present disclosure. Further, FIG. 1B, illustrates an assembled perspective view of the hydroponic system 100, in accordance with an exemplary embodiment of the present disclosure. As shown in FIGS. 1A and 1B, the hydroponic system 100 includes an apparatus for growing plants hydroponically, such as an apparatus 1000, and a nutrient feeding mechanism 2000 operatively coupled to the apparatus 1000. The apparatus 1000 will be explained in detail in conjunction with FIGS. 1A to 10 and the nutrient feeding mechanism 2000 will be explained in conjunction with FIG. 9.

As shown in FIGS. 1A and 1B, the apparatus 1000 includes a container 1100, a support assembly 1200, a plurality of baskets, such as baskets 1300a and 1300b, a plate member 1400, a roof assembly 1500, a light assembly 1600, and a plurality of door panels, such as door panels 1700a and 1700b (not shown). For the purpose of description, in the present embodiment, the plurality of baskets includes twelve baskets (hereinafter collectively referred to as “plurality of baskets 1300”) and the plurality of door panels includes four door panels (hereinafter collectively referred to as “plurality of door panels 1700”). However, it will be evident to a person skilled in the art that the present disclosure is not limited to the numbers of baskets and the number of doors as described herein.

Further, it should be understood that the structural configuration and functionality of all baskets of the plurality of baskets 1300 are similar and for the sake of brevity, the apparatus 1000 will be explained with reference to only two baskets, such as the baskets 1300a and 1300b. Similarly, all door panels of the plurality of door panels 1700 have similar structural configuration and functionality and accordingly, the apparatus 1000 will be explained with reference to two door panels, such as the door panels 1700a and 1700b.

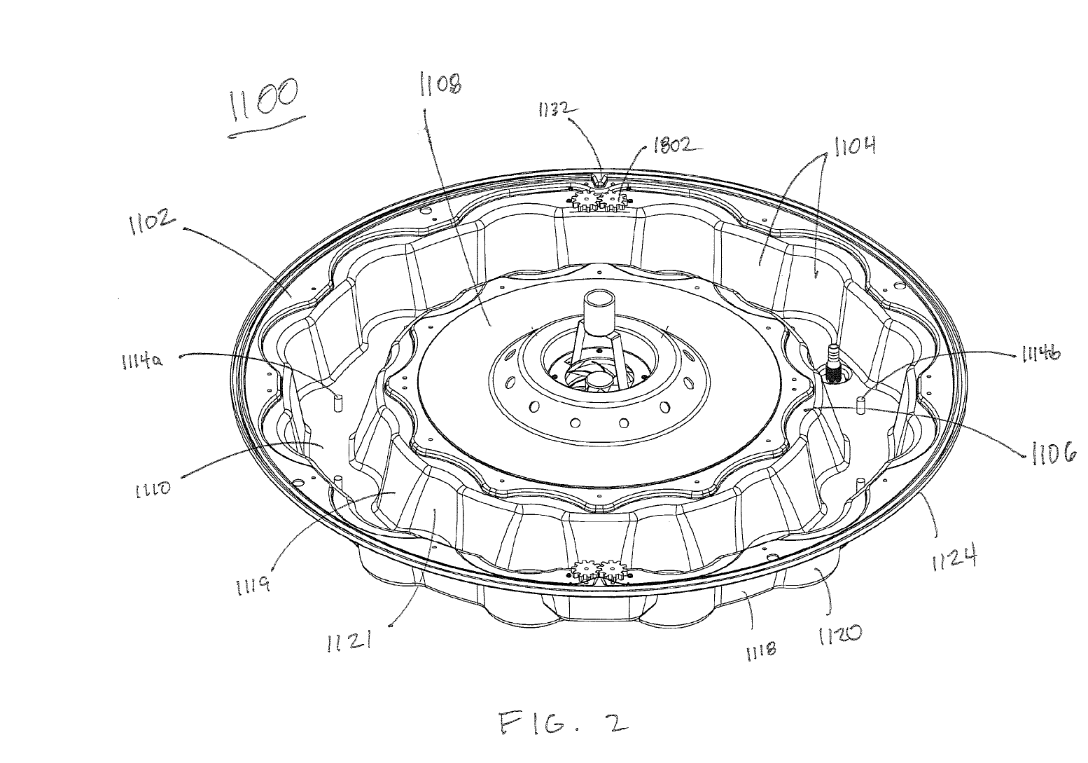

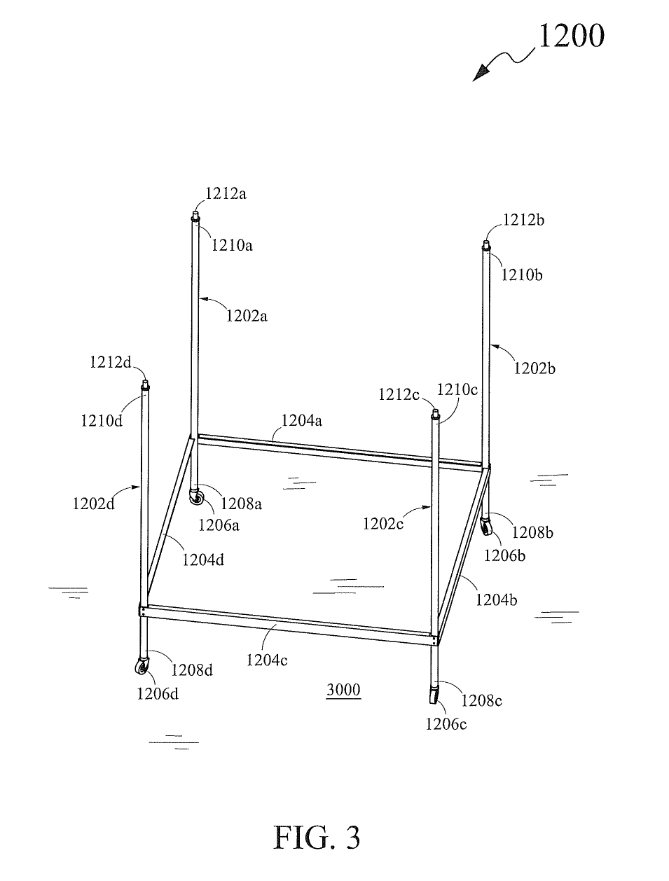

As illustrated in FIG. 1B, the support assembly 1200 supports the container 1100 above a surface 3000, such as a floor. The container 1100 and the support assembly 1200 will be explained in detail in conjunction with FIGS. 2 and 3, respectively. The container 1100 is adapted to store a nutrient fluid therein. Further, the plate member 1400 is received on the container 1100 and adapted to cover the container 1100. In the present embodiment, the plate member 1400 includes a plurality of first slots, such as first slots 1402a and 1402b (shown in FIG. 1A), configured thereon. The plurality of first slots receives the plurality of baskets 1300 therein. For example, as shown in FIG. 1B, the first slots 1402a and 1402b receive the baskets 1300a and 1300b, respectively. It will be evident to a person skilled in the art that the number of first slots, such as first slots 1402a and 1402b, configured on the plate member 1400 depends on the number of baskets, such as baskets 1302a and 1302b, in the plurality of baskets 1300. Accordingly, in the present embodiment, the plate member 1400 is configured to have twelve first slots (hereinafter collectively referred to as a plurality of first slots 1402). It should be understood that the structural configuration and the functionality of all first slots of the plurality of first slots 1402 are similar. Accordingly, for sake of brevity the plurality of first slots 1402 will be explained with reference to first slots 1402a and 1402b, only.

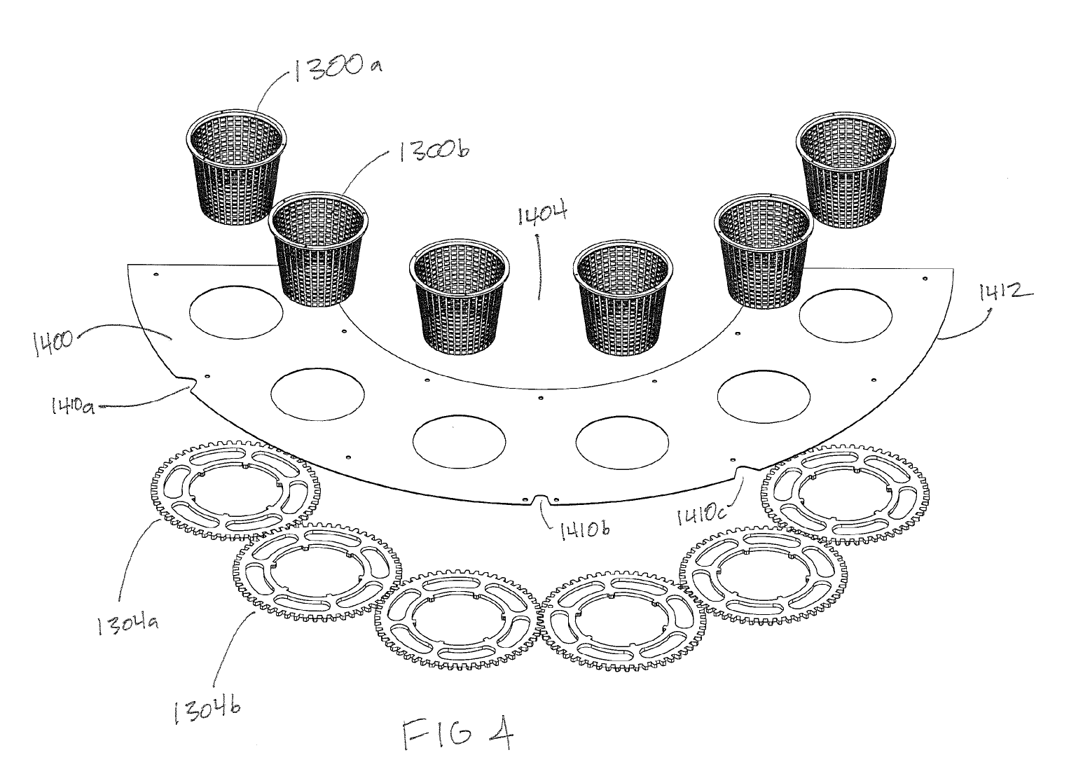

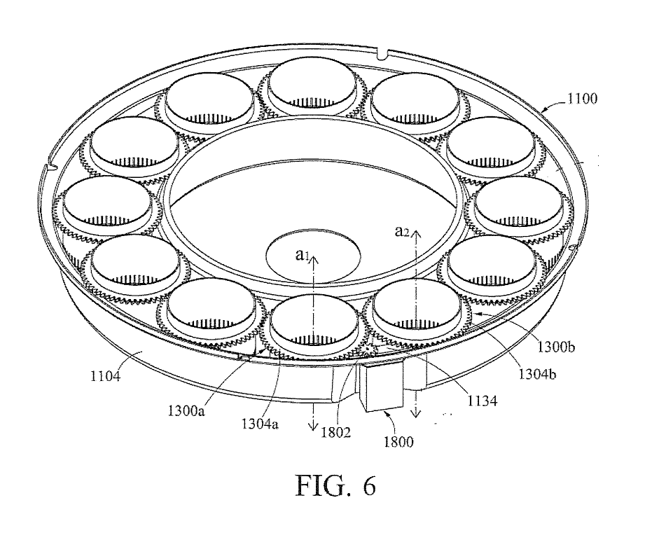

The plate member 1400, which in an embodiment, may be comprised of two attachable complimentary semicircular members, is received on the container 1100 in a manner such that the plurality of baskets 1300 received in the plurality of first slots 1402 are accommodated in the container 1100. The plurality of baskets 1300 is adapted to receive root portions of plants (not shown). Moreover, each basket, such as the baskets 1302a and 1302b, of the plurality of baskets 1300 is adapted to receive the nutrient fluid received in the container 1100. Additionally, each basket, such as baskets 1300a and 1300b, of the plurality of baskets 1300 is adapted to rotate about an axis thereof, which will be explained in conjunction with FIG. 4. The arrangement of the plurality of baskets 1300 on the plate member 1400 will be explained in detail in conjunction with FIGS. 4 and 6.

Further, as illustrated herein, the roof assembly 1500 is mounted on the support assembly 1200. Specifically, the roof assembly 1500 is mounted on the support assembly 1200 in a spaced apart relationship to the container 100 such that a hollow chamber ‘C’ is configured between the roof assembly 1500 and the plate member 1400, received on the container 1100. The hollow chamber ‘C’ is adapted to accommodate therewithin portions, such as stem portions, of the plants that are received in the plurality of baskets 1300 supported by the plate member 1400. The hollow chamber ‘C’ also accommodates the light assembly 1600 therein.

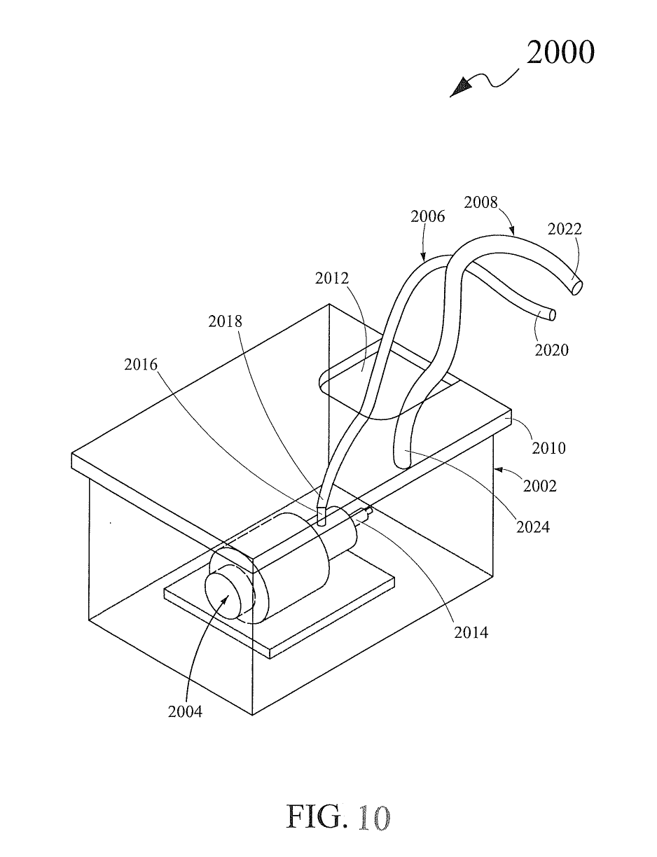

Specifically, as illustrated in FIG. 1B, the light assembly 1600 is coupled to the container 1100 such that the light assembly 1600 extends upwardly from the container 1100 and accommodated in the hollow chamber ‘C’. In the present embodiment, the light assembly 1600 extends through a central slot 1404 (shown in FIG. 1A) configured centrally on the plate member 1400. The roof assembly 1500 and the light assembly 1600 will be explained in detail in conjunction with FIGS. 9 and 10, respectively. The roof assembly 1500 movably mounts the plurality of door panels 1700 thereto. Specifically, the plurality of door panels 1700 (not shown) are movably mounted between the roof assembly 1500 and the container 1100. The plurality of door panels 1700 are adapted to be selectively moved for performing one of enclosing the hollow chamber ‘C’ therebetween, and enabling an access to the hollow chamber ‘C’. Each of the plurality of door panels 1700 includes a handle member configured thereon. For example, the door panel 1700a includes a handle member 1702a configured thereon. The handle member, such as the handle member 1702a, of the plurality of door panels enables the plurality of door panels 1700 to be selectively moved for enclosing the hollow chamber ‘C’ or enabling access to the hollow chamber ‘C’. Further, the movable mounting of the plurality of door panels 1700 to the container 1100 and the roof assembly 1500 is further explained in detail in conjunction with FIGS. 2 and 9.

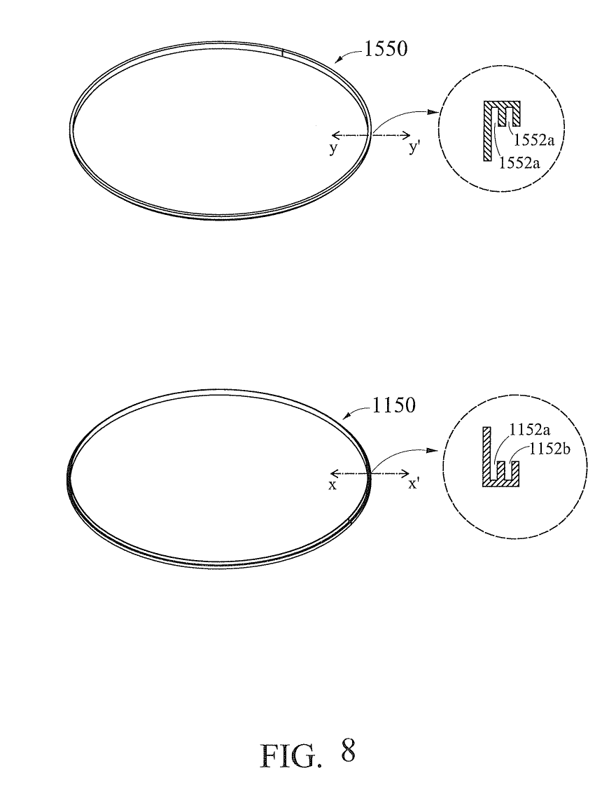

In another embodiment, the plurality of door panels may be two door panels (not shown), which panels are of an arcuate shape and which panels are received in the plurality of tracks discussed in connection with FIG. 8, to permit at least one panel to slide in a track to allow a user create an opening to gain access to the hollow chamber ‘C.’ Furthermore, at least one of the panels may be configured with a flange that projects inwardly toward or outwardly away from the chamber for providing a user with a grip to manipulate the position of the panel.

The apparatus 1000 further includes a driving assembly 1800 adapted to be mounted on the container 1100, and an air feeding assembly, such as air feeding assembly 1900, adapted to be mounted on the plate member 1400. The driving assembly 1800 is adapted to rotate each basket, such as baskets 1302a and 1302b, of the plurality of baskets 1300 about an axis thereof. The plurality of air feeding assemblies 1900 is adapted to provide air in the hollow chamber ‘C’ of the apparatus 1000.

As explained herein, the hydroponic system 100 includes the apparatus 1000 operatively coupled to the nutrient feeding mechanism 2000. The nutrient feeding mechanism 2000 includes a nutrient reservoir tank 2002, a nutrient feeding pump 2004 (shown with broken lines in FIGS. 1A and 1B), and a nutrient supplying tube 2006. The nutrient reservoir tank 2002 is capable of storing nutrient fluid (not shown) therein. The nutrient feeding pump 2004 is configured within the nutrient reservoir tank 2002 and the nutrient supplying tube 2006 is coupled to the nutrient feeding pump 2004. The nutrient feeding pump 2004 pumps the nutrient fluid into the nutrient supplying tube 2006 for delivering the nutrient fluid from the nutrient reservoir tank 2002 to the container 1100 through the nutrient supplying tube 2006. The nutrient feeding mechanism 2000 further includes a nutrient recirculating tube 2008 configured between the container 1100 and the nutrient reservoir tank 2002. The nutrient feeding mechanism 2000 is further explained in detail in conjunction with FIG. 10.

Referring now to FIG. 2, a perspective view of the container 1100 of the apparatus 1000 is illustrated, in accordance with an exemplary embodiment of the present disclosure. The container 1100 includes a base 1102 and a peripheral wall 1104 extending from a periphery of the base 1102. The container 1100 is adapted to receive the plate member 1400 thereon (shown in FIG. 1B) such that the plurality of baskets 1300 received in the plate member 1400 are supported on the base 1102 of the container 1100. The peripheral wall 1104 is adapted to mount the nutrient supplying tube 2006 thereto. The container 1100 further includes a central projecting member 1106 extending from the base 1102, which projecting member 1106 extends upwardly from a substantially central portion of the base 1102. More specifically, the projecting member 1106 is a substantially tubular structure that further comprises a shelf thereon. Further, the projecting member 1106 and the peripheral wall 1104 configure a cavity 1110 therebetween. The cavity 1110 is adapted to be covered by the plate member 1400 that is received on the container 1100. Further, the plurality of baskets 1300 are accommodated in the cavity 1110 when the plate member 1400 is received on the plurality of container 1100. In one embodiment of the present disclosure, the container 1100 is configured to assume a circular shape. However, it will be evident to a person skilled in the art that the container 1100 may be configured to assume any other shape such as, elliptical shape, and any polygonal shape.

The base 1102 of the container 1100 includes a plurality of protrusions, such as protrusions 1114a and 1114b, configured on a portion of the base 1102 between the peripheral wall 1104 and the projecting member 1106. The plurality of protrusions is adapted to support the plurality of baskets 1300 on the base 1102 of the container 1100, which will be explained in detail in conjunction with FIG. 4. The plurality of protrusions corresponds to the plurality of baskets 1300. Accordingly, in the present embodiment, the plurality of protrusions includes twelve protrusions (hereinafter collectively referred to as “plurality of protrusions 1114”). For the sake of brevity, the plurality of protrusions 1114 will explained hereinafter with reference to only two grooves, specifically protrusions 1114a and 1114b.

The base 1102 of the container 1100 further includes a drainage opening 1116, configured on the portion of the base 1102 between the peripheral wall 1104 and the hollow projecting member 1106. More specifically, in the present embodiment, the drainage opening 1116 is configured on the base 1102 between two grooves, such as the protrusions 1114a and 1114b, of the plurality of protrusions 1114. The drainage opening 1116 is fluidically coupled to the nutrient recirculating tube 2008, which is further explained in conjunction with FIG. 10. In an embodiment, the drainage opening 1116 may receive a plurality of components that are capable of regulating drainage of fluids from the container 1100. Such components may comprise a cap, a nut and washer arrangement, a drain body that may be secured in the drainage opening 1116 by way of said nut and washer, and a nutrient recirculating tube (to be described in connection with FIG. 10) that extends out of the drain body and downwardly away from the exterior of the container 1100.

Further, as illustrated herein, the peripheral wall 1104 of the container 1100 includes a plurality of indents 1118 and a plurality of arcuate segments 1120 configured thereon. A first indent is disposed immediately adjacent to a first arcuate segment, and a second indent is then disposed between the first arcuate segment and a second arcuate segment, and such dispositional pattern is followed around the entire circumference of the container 1100. The configuration of the arcuate segment is such that it corresponds to the substantially cylindrical shape of a basket that is disposed in the container adjacent to an arcuate segment. Further, the projecting member 1106 of the container 1106 may have a corresponding arcuate segment-indent pattern configuration for accommodating a cylindrical shape of a basket. The protrusions 1114 of the container 1100 are disposed on the base 1102 of the container 1100 at a point where they are concentric with a circle formed by the arcuate segment 1120 of the peripheral wall 1104 and the arcuate segment 1121 of the central projecting member 1106. The configuration of the arcuate segments facilitates rotational movement of the baskets when the baskets are installed in the container 1100.

The central projecting member 1106 of the container 1100 further comprises an aperture through which a light assembly 1600 lamp base may project upwardly into the cavity of the container. The light assembly 1600 includes a light housing 1602, an electrical socket 1604, and a light source 1606. The coupling of the light assembly 1600 with container 1100 and plate member 1400 is further explained in detail in conjunction with FIG. 9.

An air feeding assembly 1900 may be securely attached with screws, bolts, or other fasteners in proximity to the aperture of the projecting member, the operation of which assembly will be described in further detail below. In an embodiment, the assembly may comprise a fan or any other apparatus capable of generating airflow.

The peripheral wall 1104 of the container 1100 further includes a support flange portion 1124. The first support flange portion 1124 is configured at the top end portion of the peripheral wall 1104. The first support flange portion 1124 is adapted to support the plate member 1400 thereon for enabling the plate assembly 1400 to be received on the container 1100 for covering the cavity 1110.

The base 1102 of the peripheral wall 1104 further includes a shelf that corresponds in shape to the arcuate segment-indent pattern of the peripheral wall. The shelf may include a plurality of apertures that are capable of receiving fasteners (such as bolts or screws) for securing the container 1100 to other components of the apparatus. Drive gears 1802 are disposed on shelf, which gears are operatively coupled with gear members 1300 and driving assemblies 1800. In an embodiment a first drive gear is disposed on the shelf diametrically from a second drive gear, and the respective driving assembly 1800 for the first gear is correspondingly disposed on the underside of base 1102 in proximity to the first drive gear, with the second driving assembly being similarly disposed on the support flange portion.

The driving assembly 1800 may be attached to the underside of the base 1102 by way of screws, bolts, or other fasteners.

Referring now to FIG. 3, a perspective view of the support assembly 1200 is illustrated, in accordance with an exemplary embodiment of the present disclosure. The support assembly 1200 includes a plurality of vertical support members, such as vertical support members 1202a, 1202b,1202c and 1202d (hereinafter collectively referred to as a plurality of vertical support members 1202). The support assembly 1200 further includes a plurality of horizontal support members, such as horizontal support members 1204a, 1204b, 1204c and 1204c (hereinafter collectively referred to as a plurality of horizontal support members 1204). The plurality of horizontal support members 1204 is coupled to the plurality of vertical support members 1202. Specifically, each horizontal support member, such as the horizontal support members 1204a, 1204b, 1204c and 1204c, extend between two vertical support members of the plurality of vertical support members 1202. For example, as shown in FIG. 3, the horizontal support member 1204a extends between the vertical support members 1202a and 1202b Similarly, the horizontal support member 1204b extends between the vertical support members 1202b and 1202c, the horizontal support member 1204c extends between the vertical support members 1202c and 1202d, and the horizontal support member 1204d extends between the vertical support members 1202d and 1202a.

In one embodiment of the present disclosure, the coupling between the plurality of vertical support members 1202 and the plurality of horizontal support members 1204 is enabled by a screw and a hole arrangement. More particularly, each of the plurality of horizontal support members 1204 may include a mounting holes (not shown) configured on each end portion thereof. The mounting holes may receive screws therethrough for coupling the end portions of each of the plurality of horizontal support members 1204 between the corresponding vertical members of the plurality of vertical members 1202. For example, end portions of the horizontal support member 1204a are coupled to the vertical support members 1202a and 1202b. The plurality of horizontal support members 1204 are coupled to the plurality of vertical support members 1202 to configure a horizontal support structure (as shown in FIG. 3). The horizontal support structure is adapted to support the base 1102 of the container 1100 thereon (as shown in FIG. 1B). Further, the plurality of vertical support members 1202 is supported vertically on the surface 3000 such that the container 1100 supported on the horizontal support structure is positioned above the surface 3000. Moreover, the plurality of vertical support members 1202 is received by the plurality of first cut portions 1132 configured on the first support flange portion 1124 of the container 1100 for firmly securing the container 1100 on the horizontal support structure.

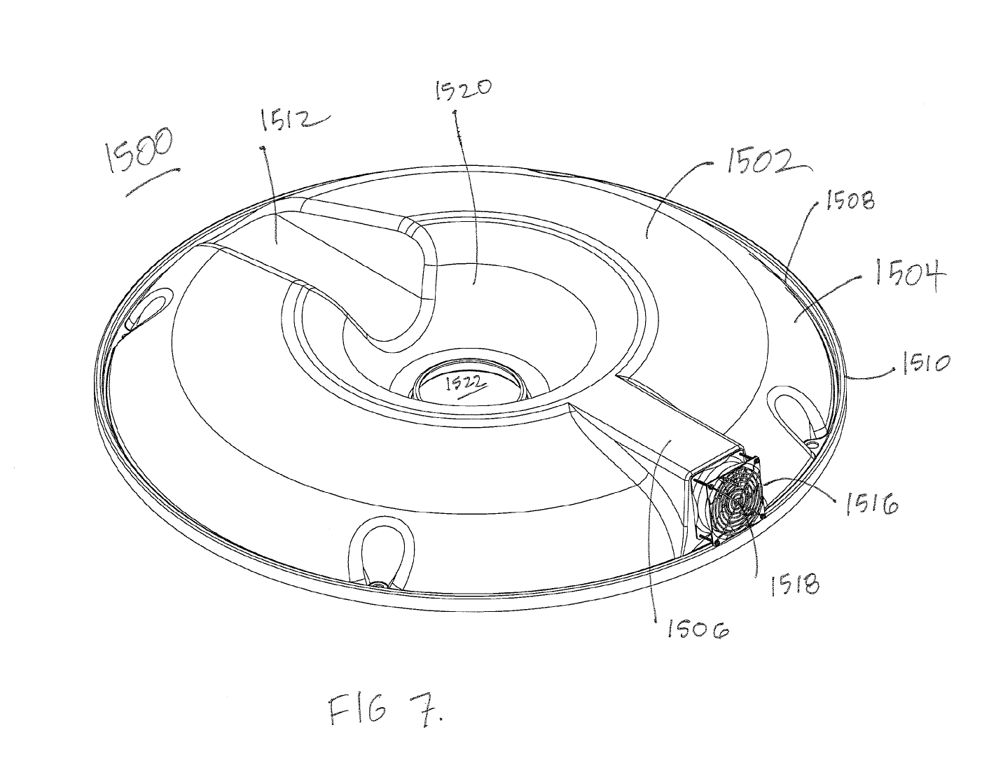

In one embodiment of the present disclosure, the support assembly 1200 of the apparatus 1000 includes a plurality of wheels, such as wheels 1206a, 1206b, 1206c, and 1206d, configured at bottom end portions of the plurality of vertical support members 1202. For example, as shown in FIG. 3, the wheels 1206a, 1206b, 1206c, and 1206d are configured at bottom end portions 1208a, 1208b, 1208c, and 1208d of the vertical support members 1202a, 1202b,1202c, and 1202d, respectively. The wheels 1206a, 1206b, 1206c, and 1206d enables in mobility of the apparatus 1000 from one place to another. Further, as explained herein, the support assembly 1200 mounts the roof assembly 1500 thereon. More specifically, the roof assembly 1500 is mounted on top end portions 1210a, 1210b, 1210c, and 1210d of the vertical support members 1202a, 1202b, 1202c, and 1202d, respectively. In one embodiment of the present disclosure, the support assembly 1200 may further includes a plurality of plugs, such as plugs 1212a, 1212b, 1212c, and 1212d, adapted to be received on the top end portions 1210a, 1210b, 1210c, and 1210d, respectively. The plurality of plugs 1212a, 1212b,1212c, and 1212d enable in rigidly mounting the roof assembly 1500 on the top end portions 1210a, 1210b, 1210c, and 1210d of the plurality of vertical support members 1202. The roof assembly 1500 and mounting thereof on the plurality of vertical support members 1202 is further explained in conjunction with FIG. 7.

Referring now to FIG. 4, an unassembled perspective view of the plurality of baskets 1300, a semicircular unit of the plate member 1400 is illustrated, in accordance with an exemplary embodiment of the present disclosure. Each basket, such as the baskets 1300a and 1300b, of the plurality of baskets 1300 includes a body member and a gear member configured on the body member. For example, the basket 1300a includes a body member 1302a and a gear member 1304a configured on the body member 1302a. Similarly, the basket 1300b includes a body member 1302b and a gear member 1304b configured on the body member 1302b. The body members of the baskets are adapted to receive root portions of plants therein. Further, the body members, such as the body members 1302a and 1302b, of plurality of baskets 1300 may be filled with fillings, such as lava rocks and cube of insulating material, for enabling in holding the root portion of the plants therein. The body members 1300 may be comprised of an at least semi-permeable material or structure, such as a lattice configuration, to allow a plant disposed therein to receive nutrient fluid and to allow a plant's roots to extend outside the body member of a basket as necessary.

The plurality of baskets 1300 further include a protrusion on the base of each basket (the base being opposite the open end of the basket, and the protrusion extending upwardly toward said open end of the basket.) The protrusion of each basket is capable of complimentarily receiving a protrusion 1114 of the bas 1102 of the container 1100 for secure attachment of a basket 1300 within the container 1100. Further, the protrusions of a basket and of the container may be circular in configuration to facilitate rotational movement of the basket.

The plurality of baskets 1300 are received by the plurality of slots 1402 configured on the plate member 1400. For example, the slot 1402a of the plate member 1400 is capable of receiving the basket 1300a. More specifically, the slot 1402a receives the upper portion 1308a of the basket 1300a therethrough in a manner such that the gear member 1304a is disposed beneath the plate member 1400. Similarly, the slot 1402b receives the upper portion 1308b of the basket 1300b therethrough such that the gear member 1304b of the basket 1300b is disposed beneath the plate member 1400. Accordingly, the plurality of slots 1402 is capable of receiving the plurality of baskets 1300 for supporting the plurality of baskets 1300 on the base 1102 of the container 1100 when the plate member 1400 is received on the container 1100.

Further, the gear members are configured proximal to upper portions of the body members. For, example, the gear members 1304a and 1304b are configured on upper portions 1308a and 1308b, respectively, of the body member members 1302a and 1302b, respectively, as shown in FIG. 4. In one embodiment of the present disclosure, each of the gear members, such as the gear members 1304a and 1304b, is a spur gear. Each gear member may include at least one protrusion on the inner ring portion of the gear member for enabling secure attachment of a gear member to a basket.

The gear members may be comprised of resilient plastic and may include a magnet disposed integrally therein, which magnet may be detectable by a magnet sensor of a driving assembly 1800 (to be described in further detail below). The plurality of baskets 1300 are adapted to be arranged in a manner on the plate member 1400 such that the gear members of the plurality of baskets 1300 are intermeshed.

For example, the gear members 1304a and 1304b of adjacent baskets, such as the baskets 1300a and 1300b intermesh with each other. Similarly, gear members of other baskets of the plurality of baskets 1300 also intermesh with adjacent baskets. Accordingly, the gear members of the plurality of baskets 1300 intermesh to configure a gear train that enables in rotating the each basket, such as the basket 1300a and the basket 1300b, of the plurality of baskets 1300 about an axis thereof. The plurality of baskets 1300 may be imparted a rotation motion with the help of the driving assembly 1800, which is explained in detail in conjunction FIGS. 7 and 8.

Further, as illustrated in FIG. 4, the plate member 1400 includes a central slot 1404. Further, when the plate member 1400 is received on the container 1100, the central slot 1404 is positioned over the hollow projecting member 1106 (shown in FIG. 2) of the container 1100.

The plate member 1400 further includes a plurality of cut out portions, such as cut out portions 1410a, b, and c, configured on a peripheral portion 1412 of the plate member 1400. The plurality of cut out portions 1410 may be aligned with the plurality of first cut portions 1132 (shown in FIG. 2), when the plate member 1400 is received on the support flange portion 1124 of the container 1100 for enabling the plate member 1400 to be received thereon. For example, when the plate member 1400 is received on the support flange portion 1124 of the container 1100, the cut out portions 1410a and 1410b are aligned with the first cut portions 1132a and 1132b, respectively.

Further, upon aligning the plurality of cut out portions 1410 with the plurality of first cut portions 1132, the plurality of vertical support members 1202 may be received therethrough for allowing the base 1102 of the container 1100 to rest on the plurality of horizontal support member 1204. For example, the vertical support member 1202a may be received by the aligned first cut portion 1132a and cut out portion 1410a, aligned therewith. Similarly, the remaining vertical support members 1202b, 1202c, and 1202d are received by the similarly aligned cut portions of container 1100 and the plate member 1400. Accordingly, the plate member 1400 is securely received on the container 1100. Moreover, it will be evident to a person skilled in the art that the shape of the plate member 1400 is dependent on the shape of the container 1110. Accordingly, in the present embodiment, the plate member 1400 is configured to assume a circular shape.

The plate member 1400 further includes a plurality of third cut portions (not shown) configured on a peripheral portion 1412 of the plate member 1400, which third cut portions are capable of accepting a wire management conduit (not shown) of the container 1100.

As explained herein, the air feeding assembly 1900 is adapted to feed air into the hollow chamber ‘C’ (shown in FIG. 1B). More specifically, the air feeding assembly may draw air from outside of the container 1100 and may distribute such air into the container through the central projecting member 1106 configured on the base 1102 of the container 1100. The air fed into the hollow chamber ‘C’ enables the plant portions, such as the stem portions, leaf portions, accommodated in the hollow chamber ‘C’ to receive fresh air. Specifically, the fed air enables any ambient oxygen to be removed from a vicinity of the plant portions and allows more carbon dioxide in the vicinity of the plant portions for aiding photosynthesis. In one embodiment of the present disclosure, the air feeding assembly 1900 may operate on electrical power received from an external power source, such as AC mains from a wall outlet. Specifically, the air feeding assembly 1900 may be electrically coupled to the wall outlet by means of electrical components, such as an electrical wire and a plug, for receiving electrical power therefrom.

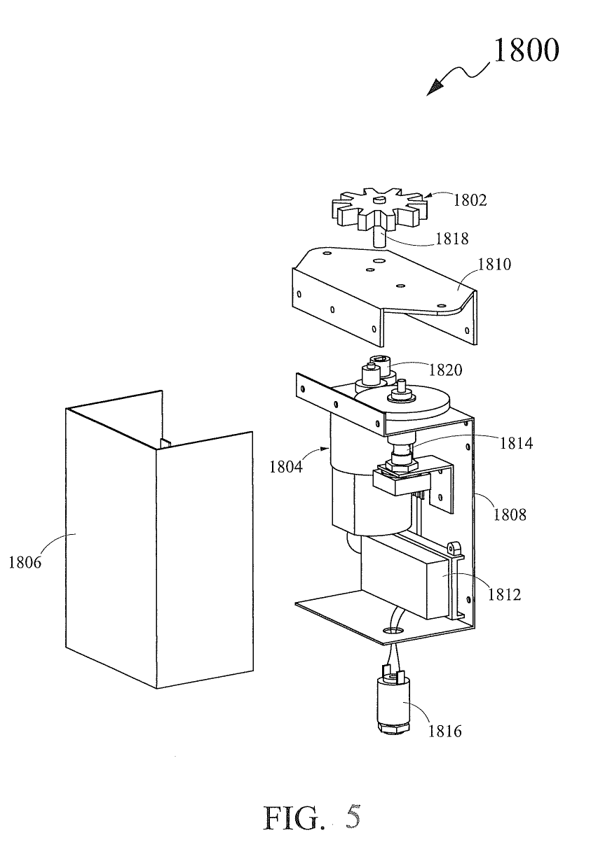

In an assembled state of the container 1100, the plurality of baskets 1300, the plate member 1400, plate member 1400 is received on the container 1100 for covering the cavity 1110 of the container 1100. The plurality of baskets 1300 is received by the plurality of first slots 1402 configured on the plate member 1400 and is accommodated in the cavity 1110 of the container 1100. The plurality of baskets 1300 may be rotated about respective axes thereof with the help of the driving assembly 1800. The driving assembly 1800 may be received under the base 1102 of the container 1100, which is further explained in detail in conjunction with FIG. 5. Further, the air feeding assembly 1900 is in proximity to the central projecting member 1106 of the container 1100.

As explained herein, the light assembly 1600 extends through the central slot 1404 configured centrally on the plate member 1400. As shown in FIG. 1B, the air feeding assembly 1900 is configured to be in proximity to the light assembly 1600. Such an arrangement of the air feeding assembly 1900 in relation to the light assembly 1600 causes air within the container 1100 to be directed away from the light assembly 1600.

Referring now to FIG. 5, an exploded perspective view of a driving assembly 1800 is illustrated, in accordance with an exemplary embodiment of the present disclosure. In an embodiment, the apparatus comprises a first driving assembly 1800a and a second driving assembly 1800b, which assemblies are adapted to be mounted on the peripheral wall 1104 of the container 1100. Specifically, the driving assembly 1800 is mounted on the underside of the base 102. Each driving assembly 1800 is adapted to rotate the each basket of the plurality of baskets 1300 about the axis thereof. The driving assembly 1800 includes a driving gear 1802 and a motor 1804 operatively coupled to the driving gear 1802. The driving assembly further includes a side cover 1806, a support cover 1808, and a top cover 1810. The support cover 1808 enables in mounting the motor 1804 thereon, and the top cover 1810 enables in mounting the driving gear 1802 thereon. Further, the driving assembly 1800 may be mounted to the support flange portion 1124 by utilizing any conventional fastening means such as a nut and screw arrangement.

The driving assembly 1800 further includes a power source 1812, a rotary encoder 1814, and a capacitor 1816. The power source 1812, the rotary encoder 1814, and the capacitor 1816 are mounted on the support cover 1808. In an embodiment, the power source 1812 is a battery which is electrically coupled to the motor 1804 for providing electrical power to operate the motor 1804. Further, in the present embodiment, the motor 1804 of the driving assembly 1800 is a Direct Current Stepper Motor. Accordingly, the power source 1812 is adapted to provide the direct current required for operation of the motor 1804. The rotary encoder 1814 is electrically coupled to the power source 1812 and is adapted to enable in changing an angular position of a shaft of the motor 1804 based on the power received from the power source 1812. More specifically, the driving assembly 1800 may further include a motor controller (not shown) which enables is directing power from the power source 1812 to the rotary encoder 1814. Further, the capacitor 1816 is electrically coupled to the power source 1812. Specifically, the capacitor 1816 may be provided to store electrical energy which may be provided to the power source 1812 when the power source 1812 partially drains out. Additionally, in one embodiment of the present disclosure, the power source 1812 may be a rechargeable battery. At least one driving assembly 1800 of the two driving assembly may further comprise a magnet sensor and a sequencing relay disposed in proximity to the rotary encoder 1814 which sensor may sense a magnet, such as the magnet disposed on a gear member 1304, and which relay enables changing a direction of rotation of the rotary encoder 1814.

The driving assembly 1800 further includes a driving shaft 1818, coupled to the driving gear 1802, and a coupling means 1820, coupled to a shaft (not shown) of the motor 1804. The coupling means 1820 enables in coupling the driving shaft 1818 with the shaft of the motor 1804, thereby enabling in transmitting a rotational movement of the shaft of the motor 1804 to the driving shaft 1818 for rotating the driving gear 1802. Further as explained herein, the driving assembly 1800 is adapted to rotate each basket of the plurality of baskets 1300 about an axis thereof. More specifically, the driving gear 1802 is rotated by the motor 1804 for rotating the plurality of baskets 1300. An arrangement of the driving assembly 1800 with the plurality of baskets 1300 is explained in detail conjunction with FIG. 6.

The first and second driving assemblies 1800 may be wired in parallel and may be operatively coupled by way of the wire management conduit (not shown) described in connection with the container 1100. Furthermore, the assemblies 1800 may be operatively coupled to a remote control unit, which remote unit is capable of controlling operational parameters of the driving assemblies such as, but not limited to, rotational speed, rotational direction, a period of operation, starting and stopping of operation, and the like.

Referring now to FIG. 6, the arrangement between the plurality of baskets 1300 and the driving assembly 1800 is illustrated, in accordance with an exemplary embodiment of the present disclosure. Specifically, the plurality of baskets 1300 is received within the cavity 1110 of the container 1100 such that the gear members, such as the gear members 1304a and 1304b, of the plurality of baskets 1300 are intermeshed to form a gear train, as explained in conjunction with FIG. 4. The driving assembly 1800 is mounted on the support flange portion 1124 of the container 1100 in a manner such that the driving gear 1802 of the driving assembly 1800 is adapted to be received on a top side of the support flange portion 1124. Specifically, the support flange portion 1124 has an opening (not shown) through which the driving shaft 1818 is received for receiving the driving gear 1802 on the support flange 1124.

The driving gear 1802 meshes with one gear member of the gear members of the plurality of baskets 1300. As shown in FIG. 6, the driving gear 1802 meshes with the gear member 1304a of the basket 1300a such that a rotation of the driving gear 1802 imparts a rotational motion to the basket 1300a about an axis ‘a₁’ thereof. The rotation of basket 1300a imparts a rotational motion to the basket 1300b due to intermeshed gear members 1304a and 1304b. Accordingly, the basket 1300b rotates about an axis ‘a₂’ thereof. Similarly, each basket of the plurality of baskets 1300 is adapted to rotate about respective axis thereof. Such a rotation of the plurality of baskets 1300 enables the plants received in the plurality of baskets 1300 to rotate about the light assembly 1600, which further enables leafs of the plants to uniformly receive the light energy from the light assembly 1600. In the present embodiment, the motor 1804 rotates each basket of the plurality of baskets 1300 by about 1/16th of a complete rotation in 11.25 minutes. Accordingly, each basket of the plurality of baskets 1300 rotates one complete rotation (360 degrees) in 4 hours. Once one complete rotation of each basket of the plurality of baskets 1300 is completed in a particular direction, such as a clockwise direction, the plurality of baskets 1300 are rotated in an opposite direction, such as anti-clockwise direction.

Referring now to FIG. 7, an exploded perspective view of the roof assembly 1500 of the apparatus 1000 is illustrated, in accordance with an exemplary embodiment of the present disclosure. The roof assembly 1500 includes a roof plate 1502 and a roof skirt 1504 extending downwardly from a periphery of the roof plate 1502. The roof skirt 1504 is adapted to be mounted on the top end portions 1210a, 1210b, 1210c, and 1210d of the plurality of vertical support members 1202 of the support assembly 1200. The roof skirt 1504 includes a first skirt flange 1508 and a second skirt flange 1510. Specifically, the first skirt flange 1508 is configured at a bottom periphery of the roof skirt 1504 and extends horizontally outward therefrom. Further, the second skirt flange 1510 extends vertically upward from a periphery of the first skirt flange 1508.

The first skirt flange 1508 includes a plurality of support holes, (not shown) configured thereon. In an embodiment, four support holes are adapted to receive the top end portions 1210a, 1210b, 1210c, and 1210d (shown in FIG. 3) of the plurality of vertical support members 1202. Upon receiving the top end portions 1210a, 1210b, 1210c, and 1210d of the plurality of vertical support members 1202 through the plurality of support holes 1512, the plurality of plugs 1212a, 1212b,1212c, and 1212d (shown in FIG. 3), is adapted to be received on the top end portions 1210a, 1210b, 1210c, and 1210d, respectively. Accordingly, the first skirt flange 1508 of the roof skirt 1504 is received between the plurality of plugs 1212a, 1212b,1212c, and 1212d, and the top end portions 1210a, 1210b, 1210c, and 1210d of the plurality of vertical support members 1202 which enables in mounting the roof assembly 1500 on the top end portions 1210a, 1210b, 1210c of the vertical support members 1202.

Referring again to FIG. 7, the roof skirt 1504 of the roof assembly 1500 further includes a channel 1512 extending radially away from the center of the roof assembly, which channel may accommodate exhaust ducting (not shown) for removing air from the vicinity of the apparatus. The roof assembly further comprises an exhaust fan duct 1506 integrally formed in the roof plate 1502 and the roof skirt 1504, which duct 1506 may accommodate an exhaust fan, such as an exhaust fan 1516, therein. More specifically, the exhaust fan 1516 is adapted to be mounted at the circumference of the roof assembly 1500 with the help of a suitable fastening mechanism (not shown), such as screws, rivets and the like. The fan 1506 further comprises a removable grating 1518 for protecting a user from coming in contact with the fan blades.

Upon mounting the roof assembly 1500 on the support assembly 1200 (as shown in FIG. 1B) to configure the hollow chamber ‘C’ between the plate member 1400 and the roof assembly 1500, the exhaust fan 1516 may be utilized for pulling out air from the hollow chamber ‘C’. More specifically, the exhaust fan 1516 enables in pulling out air provided by the air feeding assembly 1900. The air provided by the air feeding assembly 1900 may accumulate in the hollow chamber ‘C’. Moreover, the accumulated air may become heated up due to the light assembly 1600 accommodated in the hollow chamber ‘C’. Accordingly, the exhaust fan 1516 enables in releasing the air from the hollow chamber ‘C’, thereby also regulating temperature within the hollow chamber ‘C’. More particularly, based on a desired temperature within the hollow chamber ‘C’, the exhaust fan 1516 may be operated for regulating the temperature within the hollow chamber ‘C’. For example, the exhaust fan 1516 may be turned OFF such that the light assembly 1600 heats up the air within the hollow chamber ‘C’, thereby maintaining a high temperature therewithin. In one embodiment of the present disclosure, the exhaust fan 1516 may operate on electrical power received from an external power source, such as AC mains from a wall outlet. Specifically, the exhaust fan 1516 may be electrically coupled to the wall outlet by means of electrical components, such as an electrical wire and a plug, for receiving electrical power form the wall outlet.

The roof skirt 1504 of the roof assembly 1500 includes a plurality of indentations 1518 configured thereon. The indentations facilitate stacking of one apparatus on another apparatus.

The roof plate 1502 of the roof assembly 1500 further includes a projecting member 1520 having a roof opening 1522. The projecting member 1520 protrudes downwardly from the central portion of the roof plate 1502 and the roof opening 1522 is configured centrally on the projecting member 1520. More specifically, in the present embodiment projecting member 1520 is configured to assume a hollow conical shaped structure, extending downwardly from the central portion of the roof plate 1502.

Further, as explained herein, the roof assembly 1500 and the container 1100 movably mounts the plurality of door panels 1700 therebetween. In the present embodiment, the movable mounting of the plurality door panels 1700 between the roof assembly 1500 and the container 1100 is enabled by a track assembly, which is explained in detail in conjunction with FIG. 8. Referring to FIG. 6, a perspective view of a first set of tracks 1150 and a second set of tracks 1550 is illustrated, in accordance with an exemplary embodiment of the present disclosure. The first set of tracks 1150 and the second set of tracks 1550 are structurally similar to each other. Further, the first set of tracks 1150 is integrally mounted on the peripheral wall 1104 of the container 1100, and the second set of tracks 1550 is integrally mounted on the roof skirt 1504 of roof assembly 1500.

Further, the first set of tracks 1150 and the second set of tracks 1550 are mounted to the container 1100 and the roof assembly 1500, respectively, in a manner such that the first set of tracks 1150 and second set of tracks 1550 are aligned parallel to each other. Such an arrangement of the first set of tracks 1150 and the second set of tracks 1550 enable the plurality of door panels 1700 to be movably mounted between the container 1100 and the roof assembly 1500. Specifically, the first set of tracks 1150 is adapted to receive bottom end portions of the plurality of door panels 1700 thereon for enabling the plurality of door panels 1700 to slidably move along the first set of tracks 1150. More specifically, as shown in FIG. 6, an enlarged cross sectional view of the first set of tracks 1150 along an axis x-x′ illustrates that the first set of tracks 1150 is configured to have two track grooves 1152a and 1152b configured thereon. Each of the track grooves 1152a and 1152b is capable of receiving the bottom end portions of two door panels of the plurality of door panels 1700.

The second set of tracks 1550 is adapted to receive top end portions of the plurality of door panels 1700 thereon for enabling the plurality of door panels 1700 to slidably move along the second set of tracks 1550. More specifically, as shown in FIG. 6, an enlarged cross sectional view of the second set of tracks 1550 along an axis y-y′ illustrates that the second set of tracks 1550 is configured to have two track grooves 1552a and 1552b configured thereon. The track grooves 1552a and 1552b are similar in configuration to the track grooves 1152a and 1152b and are capable of receiving the top end portions of the plurality of door panels 1700. Specifically, each of the track grooves 1552a and 1552b receives the top end portions of two door panels of the plurality of door panels 1700.

Referring now to FIG. 9, an exploded perspective view of the light assembly 1600 of the apparatus 1000 is illustrated, in accordance with an exemplary embodiment of the present disclosure. The light assembly 1600 includes a light housing 1602, an electrical socket 1604, and a light source 1606.

In the present embodiment, the light housing 1602 is configured to assume a hollow cylindrical structure. However, it will be evident to a person skilled in the art that the light housing 1602 may be configured to have other structural configurations, such as hollow polygonal structures. The light housing 1602 is composed of a borosilicate glass material. Moreover, in one embodiment of the present disclosure, the electrical socket 1604 is a ceramic lamp socket.

As shown in FIG. 9, the electrical socket 1604 is accommodated within a first end of the light housing 1602 and is coupled thereto. More specifically, the electrical socket 1604 includes a plurality of mounting brackets, such as mounting brackets 1616a, 1616b, and 1616c (hereinafter collectively referred to as a plurality of mounting brackets 1616), configured at an end portion of the electrical socket 1604. The plurality of mounting brackets 1616 enables in coupling the electrical socket 1604 to the light housing 1602.

The plurality of mounting brackets 1616 further enables in the light housing 1602 with the aperture of the central projecting member 1106 of the container 1100. More specifically, the housing 1602 is received within the aperture of the projecting member 1106 such that flange holes configured on the edge of the aperture aligns with a plurality of holes configured on an end portion of the light housing 1602. Thereafter, a suitable fastening mechanism, such as a plurality of screws or rivets (not shown), may be inserted through the aligned holes and the plurality of mounting brackets 1616, thereby coupling the aperture of the projecting member 1106 with the light housing 1602.

Further, it will be apparent that a height of the light assembly 1600 with respect to the roof assembly 1500 may be configured such that the end of the light housing 1602 that is proximate to the roof assembly will permit the roof assembly to be attached without interfering with the positioning of the light assembly 1600. Furthermore, the light assembly 1600 may be substantially centrally located within the hollow chamber ‘C’, as shown in FIG. 1B.

As illustrated herein, the light source 1606 is adapted to be operatively coupled to the electrical socket 1604. More specifically, the light source 1606 is coupled to the electrical socket 1604 and is accommodated within the intermediate portion 1612 of the light housing 1602. As explained herein, the intermediate portion 1612 is composed of the borosilicate glass material. The borosilicate glass material enables in preventing heat energy, generated by the light source 1606, from escaping from the light housing 1602. Accordingly, the intermediate portion 1612 enables in avoiding an adverse effect on the growth of the plants accommodated in the hollow chamber ‘C’. Specifically, the intermediate portion 1612 enables in avoiding the burning of leafs of the plants due to heat energy of the light source 1606.

Further, the light source 1606 is operatively coupled to the electrical socket 1604 for receiving electrical power to produce light energy. The light energy illuminates the hollow chamber ‘C’ thereby enabling the portions of the plants, accommodated in the hollow chamber ‘C’ to perform photosynthesis. Due to a substantially central location of the light assembly 1600 within the hollow chamber ‘C’, the light energy from the light source 1606 is uniformly received by the portions of plants accommodated in the hollow chamber ‘C’. Additionally, as explained herein, each basket of the plurality of baskets 1300 are adapted to rotate about the axis thereof, which further enables the portions of plants to uniformly receive the light energy from the light source 1606 for uniform growth thereof. In the present embodiment, the light source 1606 may be a standard agricultural lamp.

Referring now to FIG. 10, the nutrient feeding mechanism 2000 will be explained in detail. Specifically, the nutrient feeding mechanism 2000 enables in delivering nutrient fluid to the plants supported on the plurality of baskets 1300. As described herein, the nutrient feeding mechanism 2000 includes the nutrient reservoir tank 2002, the nutrient feeding pump 2004, and the nutrient supplying tube 2006. The nutrient reservoir tank 2002 is capable of storing nutrient fluid (not shown) therein. The nutrient feeding pump 2004 is configured within the nutrient reservoir tank 2002. The nutrient supplying tube 2006 is coupled to the nutrient feeding pump 2004. The nutrient feeding mechanism 2000 further includes the nutrient recirculating tube 2008 configured between the container 1100 and the nutrient reservoir tank 2002.

In one embodiment of the present disclosure, the nutrient reservoir tank 2002 is configured to assume a hollow cuboidal structure. The nutrient reservoir tank 2002 includes a cover 2010 adapted to be placed on a top portion of the nutrient reservoir tank 2002 for covering the nutrient fluid stored in nutrient reservoir tank 2002. Specifically, the cover 2010 enables in avoiding debris to fall into the nutrient reservoir tank 2002. The cover 2010 further enables in reducing evaporation of the nutrient fluid from the nutrient reservoir tank 2002. The cover 2010 includes a cover opening 2012 configured thereon. The cover opening 2012 is adapted to receive the nutrient supplying tube 2006 and the nutrient recirculating tube 2008 therethrough.

The nutrient feeding pump 2004 is adapted to be received within the nutrient reservoir tank 2002. In the present embodiment, the nutrient feeding pump 2004 is a submersible pump coupled to a base of the nutrient reservoir tank 2002 such that the nutrient feeding pump 2004 is submerged in the nutrient fluid stored in the nutrient reservoir tank 2002. The nutrient feeding pump 2004 includes an inlet port 2014 and an outlet port 2016. The inlet port 2014 is adapted to receive the nutrient fluid stored in the nutrient reservoir tank 2002. The outlet port 2016 is fluidically coupled to the nutrient supplying tube 2006. The nutrient feeding pump 2004 is adapted to pump the nutrient fluid into the nutrient supplying tube 2006. More specifically, the inlet port 2014 is adapted to receive the nutrient fluid from the nutrient reservoir tank 2002 and the outlet port 2016 is adapted to deliver the nutrient fluid to the nutrient supplying tube 2006 due to the pumping action of the nutrient feeding pump 2004. In one embodiment of the present disclosure, the nutrient feeding pump 2004 may operate on electrical power received from an external power source, such as Ac main from a wall outlet. Specifically, the nutrient feeding pump 2004 may be electrically coupled to the wall outlet by means of electrical components, such as an electrical wire and a plug, for receiving the electrical power therefrom.

The nutrient supplying tube 2006 includes a first end portion 2018 coupled to the nutrient feeding pump 2004 and a second end portion 2020 coupled to the peripheral wall 1104 of the container 1100. More specifically, the first end portion 2018 of the nutrient supplying tube 2006 is coupled to the outlet port 2016 of the nutrient feeding pump 2004. Further, as explained in conjunction with FIG. 10, the second end portion 2020 of the nutrient supplying tube 2006 is fluidically coupled the indent opening 1122, configured on the first indent 1118. In one embodiment of present disclosure, the coupling of the nutrient supplying tube 2006 to the first indent 1118 of the peripheral wall 1104 is enabled by a threadable arrangement. More specifically, the second end portion 2020 of the nutrient supplying tube 2006 may include external threads (not shown) configured thereon and the indent opening 1122 may include internal treads (not shown). The external threads of the second end portion 2020 meshes with the internal threads of the indent opening 1122 thereby coupling the nutrient supplying tube 2006 to the peripheral wall 1104 of the container 1100.

As explained herein, the nutrient supplying tube 2006 enables in supplying the nutrient fluid to the container 1100. Specifically, the nutrient fluid is pumped by the nutrient feeding pump 2004 into the nutrient supplying tube 2006 which is received by the second cavity 1110 of the container 1100. Accordingly, the second cavity 1110 stores the nutrient fluid therein. The stored nutrient fluid in the second cavity 1110 of the container 1100 is received in the plurality of baskets 1300. The root portions of the plants may absorb a portion of the nutrient fluid.

Further, the nutrient fluid stored in the container 1100 may be drained therefrom when required and delivered back to the nutrient reservoir tank 2002 for reuse. Specifically, the nutrient recirculating tube 2008 enables in delivering the excess amount of nutrient fluid from the container 1100 to the nutrient reservoir tank 2002 for the reuse of the nutrient fluid. Further, as explained in conjunction with FIG. 2, the base 1102 of the container 1100 includes the drainage opening 1116 configured thereon. The drainage opening 1116 is fluidically coupled to the nutrient recirculating tube 2008 for enabling in draining the nutrient fluid from the container 1100 and delivering the nutrient fluid to the nutrient reservoir tank 2002. More specifically, the nutrient recirculating tube 2008 includes a first end portion 2022 adapted to be coupled to the drainage opening 1116, and a second end portion 2024 adapted to be received into the nutrient reservoir tank 2002 through the cover opening 2012.

In one embodiment of present disclosure, the mounting of the nutrient recirculating tube 2008 on the drainage opening 1116 is enabled by a threadable arrangement. More specifically, the first end portion 2022 of the nutrient recirculating tube 2008 may include external threads (not shown) and the drainage opening 1116 may include internal threads (not shown). The external threads of the first end portion 2022 meshes with the internal threads of the drainage opening 1116 thereby coupling the nutrient recirculating tube 2008 to the drainage opening 1116.

The system, as explained herein conjunction with FIGS. 1A through 10, may be used for growing plants hydroponically. Specifically, an apparatus, such as the apparatus 1000, of the hydroponic system 100 is used in conjunction with a nutrient feeding mechanism, such as the nutrient feeding mechanism 2000, to grow plants hydroponically. The nutrient feeding mechanism is adapted to deliver nutrient fluid to a container, such as the container 1100, accommodating a plurality of baskets, such as plurality of baskets 1300, therein. Accordingly, root portions of the plants, received in the plurality of baskets, may be dipped in the nutrient fluid, to grow plants hydroponically. The hydroponic system of the present disclosure further enables in providing a controlled environment to grow the plants. More specifically, the hydroponic system enables in providing the controlled environment by controlling operations of the nutrient feeding pump, a light assembly (such as the light assembly 1600), a driving assembly (such as the driving assembly 1800), an air feeding assembly (such as the air feeding assembly 1900), and an exhaust fan, (such as the exhaust fan 1516). For example, the nutrient feeding pump may be coupled to a common interval timer which enables the nutrient feeding pump to pump nutrient fluid into the container once in every 1-12 hours, thereby providing a required amount of nutrient fluid to the plants. Further, an excess amount of nutrient fluid may be drains out from the container when required.

Further, the light assembly may be selectively operated based on the ambient light or the requirement of the plants. Furthermore, the plurality of baskets is uniformly arranged around the light assembly, thereby enabling the plants in the plurality of baskets to receive light energy uniformly from the light assembly. Moreover, the driving assembly enables in uniformly rotating the plurality of baskets about the respective axis thereof, thereby further enabling leaves of the plants to receive uniform light energy from a light source of the light assembly for the uniform growth of the plants. Additionally, the air feeding assembly and the exhaust fan may be operated for regulating a temperature within a hollow chamber, such as the hollow chamber ‘C’, thereby providing suitable temperature for the growth of the plants accommodated in the hollow chamber.

Also, the apparatus of the system is a closed configuration that encloses the plants, thereby shielding the plants from exposure to ambient light and noise, which avoids adverse and stress-related effects on the plants' growth. More specifically, the plurality of door panels enables the apparatus to assume the closed configuration. Moreover, the plurality of door panels enables in reflecting the light energy provided by light assembly towards the plants accommodated in hollow chamber. Most importantly, the plurality of door panels prevents entry of ambient light within the hollow chamber during the plants' night cycle (during which important hormonal processes may occur.) Accordingly, the various above mentioned features of the system enable in providing the controlled environment for growing plants hydroponically.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present disclosure.

What is claimed is:

1. A hydroponic system for providing a controlled environment to grow plants, the system comprising:
an apparatus for growing plants hydroponically, the apparatus comprising
a container comprising a base, a peripheral wall extending from a periphery of the base, and a hollow projecting member extending upwardly from a substantially central portion of the base, the hollow projecting member and peripheral wall enclosing a cavity therewithin, wherein the cavity is adapted to store a nutrient fluid therein,
a support assembly to support the container above a surface,
a plate member received on the container for covering the cavity, the plate member having a plurality of slots configured thereon;
a plurality of baskets received by the plurality of slots of the plate member such that the plurality of baskets is supported on the base of the container and are accommodated in the cavity of the container, the plurality of baskets being capable of holding root portions of the plants therein, wherein each of the plurality of baskets is adapted to rotate about an axis thereof, and wherein the each of the plurality of baskets is adapted to receive the nutrient fluid stored in the cavity for growing the plants hydroponically,
a roof assembly mounted on the support assembly in a spaced apart relationship to the container to configure a hollow chamber between the roof assembly and the plate member received on the container,
a light assembly coupled to the base in a manner such that the light assembly is accommodated in the hollow chamber, and
a plurality of door panels movably mounted between the roof assembly and the container, the plurality of door panels adapted to be selectively moved for performing one of enclosing the hollow chamber therebetween and enabling an access to the hollow chamber; and
a nutrient feeding mechanism operatively coupled to the apparatus for growing plants hydroponically, the nutrient feeding mechanism comprising
a nutrient reservoir tank capable of storing nutrient fluid therein,
a nutrient feeding pump configured within the nutrient reservoir tank, and
a nutrient supplying tube having a first end portion coupled to the nutrient feeding pump, and a second end portion coupled to the peripheral wall of the container,
wherein the nutrient feeding pump pumps the nutrient fluid into the nutrient supplying tube for delivering the nutrient fluid from the nutrient reservoir tank to the cavity, and
wherein a portion of the nutrient fluid is absorbed by the root portions of the plants received in the plurality of baskets.

2. The system of claim 1, wherein the nutrient feeding mechanism further comprises a nutrient recirculating tube coupled to the base of the container and extending to the nutrient reservoir tank, the nutrient recirculating tube adapted to drain the nutrient fluid from the cavity and deliver the nutrient fluid to the nutrient reservoir tank.

3. The system of claim 1, wherein the each of the plurality of baskets of the apparatus comprises:
a body member adapted to receive a root portion of a plant therein, the body member having an at least semi-permeable material or structure for receiving the nutrient fluid received in the cavity of the container; and
a gear member removably attached to body member.

4. The system of claim 3, wherein the each of the plurality of baskets further comprises a protrusion configured at a bottom face of the body member.

5. The system of claim 4, wherein the base of the container comprises a plurality of protrusions, each of the plurality of protrusions being adapted to be received within a protrusion of a basket of the plurality of baskets for supporting the plurality of baskets on the base of the container.

6. The system of claim 3, wherein gear members of the plurality of baskets are intermeshed to configure a gear train.

7. The system of claim 6, wherein apparatus further comprises at least one driving assembly mounted on the peripheral wall of the container, the at least one driving assembly being adapted to rotate the gear members of the gear train for rotating the each of the plurality of baskets about the axis thereof.

8. The system of claim 7, wherein the driving assembly comprises:
at least one driving gear functionally coupled to a gear member of the gear train; and
a motor functionally coupled to at least one driving gear, the motor being adapted to rotate the at least one driving gear for rotating the gear member of the gear train thereby rotating the gear members of the gear train for rotating the each of the plurality of baskets about the axis thereof.

9. The system of claim 1, wherein the plate member of the apparatus further comprises a central slot configured at a substantially central portion of the plate member such that the central slot is positioned over the hollow projecting member of the container.

10. The system of claim 9, wherein the apparatus further comprises an of air feeding assembly mounted in proximity to the hollow projecting member of the container, the air feeding assembly adapted to feed air into the hollow chamber, and wherein said air feeding assembly comprises
a fan housing having a plurality of vents configured thereon, the fan housing mounted on a second slot of the plurality of second slots; and
an air feeding fan mounted within a bottom portion of the fan housing.

11. The system of claim 1, wherein the roof assembly of the apparatus comprises:
a roof plate; and
a roof skirt extending downwardly from a periphery of the roof plate, the roof skirt being mounted on the support assembly for supporting the roof assembly thereon,
wherein the roof skirt comprises a channel for accommodating exhaust ducting to draw air out of the container,
wherein the roof skirt comprises an exhaust fan duct for accommodating an exhaust fan therewithin, and
wherein the roof skirt comprises a plurality of indentations for supporting a second apparatus that may be stacked on said roof skirt of a first apparatus.

12. The system of claim 1, wherein the light assembly of the apparatus comprises:
a light housing coupled to the container and extending upwardly into the hollow chamber;
an electrical socket accommodated within the light housing; and
a light source accommodated within the light housing and electrically coupled to the electrical socket, the light source being adapted to illuminate the hollow chamber.

13. The system of claim 1, wherein the apparatus further comprises a first set of tracks mounted on the container and a second set of tracks mounted on the roof assembly, wherein the first set of tracks and the second set of tracks are adapted to receive bottom portions and top portions, respectively, of the plurality of door panels thereon for movably mounting the plurality of door panels between the container and the roof assembly.

14. The system of claim 1, wherein the support assembly of the apparatus comprises:
a plurality of vertical support members supported vertically on the surface; and
a plurality of horizontal support members coupled to the plurality of vertical support members in a manner such that each of the plurality of horizontal support members extends between two vertical support members of the plurality of vertical support members to configure a horizontal support structure for supporting the base of the container thereon, and
wherein the support assembly further comprises a plurality of wheels configured at bottom end portions of the plurality of vertical support members, the plurality of wheels adapted to enable mobility of the apparatus from one place to another.

15. An apparatus for providing a controlled environment to grow plants hydroponically, the apparatus comprising:
a container comprising a base, a peripheral wall extending from a periphery of the base, and a hollow projecting member extending upwardly from a substantially central portion of the base, the hollow projecting member and peripheral wall enclosing a cavity therewithin, wherein the cavity is adapted to store a nutrient fluid therein,
a support assembly to support the container above a surface,
a plate member received on the container for covering the cavity, the plate member having a plurality of slots configured thereon;
a plurality of baskets received by the plurality of slots of the plate member such that the plurality of baskets is supported on the base of the container and are accommodated in the cavity of the container, the plurality of baskets being capable of holding root portions of the plants therein, wherein each of the plurality of baskets is adapted to rotate about an axis thereof, and wherein the each of the plurality of baskets is adapted to receive the nutrient fluid stored in the cavity for growing the plants hydroponically,
a roof assembly mounted on the support assembly in a spaced apart relationship to the container to configure a hollow chamber between the roof assembly and the plate member received on the container,
a light assembly coupled to the base in a manner such that the light assembly is accommodated in the hollow chamber,
a plurality of door panels movably mounted between the roof assembly and the container, the plurality of door panels adapted to be selectively moved for performing one of enclosing the hollow chamber therebetween and enabling an access to the hollow chamber, and
an air feeding assembly mounted in proximity to the hollow projecting member of the container, the air feeding assembly adapted to feed air into the hollow chamber, and wherein said air feeding assembly comprises
a fan housing having a plurality of vents configured thereon, the fan housing mounted on a second slot of the plurality of second slots; and
an air feeding fan mounted within a bottom portion of the fan housing.

16. The apparatus of claim 16, wherein the each of the plurality of baskets of the apparatus comprises:
a body member adapted to receive a root portion of a plant therein, the body member having an at least semi-permeable material or structure for receiving the nutrient fluid received in the cavity of the container; and
a gear member removably attached to body member.

17. The apparatus of claim 17, wherein the each of the plurality of baskets further comprises a protrusion configured at a bottom face of the body member.

18. The apparatus of claim 16, wherein the base of the container comprises a plurality of protrusions, each of the plurality of protrusions being adapted to be received within a protrusion of a basket of the plurality of baskets for supporting the plurality of baskets on the base of the container.

19. The apparatus of claim 17, wherein gear members of the plurality of baskets are intermeshed to configure a gear train.

20. The apparatus of claim 16, wherein apparatus further comprises at least one driving assembly mounted on the peripheral wall of the container, the at least one driving assembly being adapted to rotate the gear members of the gear train for rotating the each of the plurality of baskets about the axis thereof, and
wherein the driving assembly comprises at least one driving gear functionally coupled to a gear member of the gear train; and
a motor functionally coupled to at least one driving gear, the motor being adapted to rotate the at least one driving gear for rotating the gear member of the gear train thereby rotating the gear members of the gear train for rotating the each of the plurality of baskets about the axis thereof.

21. The apparatus of claim 16, wherein the plate member further comprises a central slot configured at a substantially central portion of the plate member such that the central slot is positioned over the hollow projecting member of the container.

22. The apparatus of claim 16, wherein the roof assembly further comprises a roof plate; and
a roof skirt extending downwardly from a periphery of the roof plate, the roof skirt being mounted on the support assembly for supporting the roof assembly thereon,
wherein the roof skirt comprises a channel for accommodating exhaust ducting to draw air out of the container,
wherein the roof skirt comprises an exhaust fan duct for accommodating an exhaust fan therewithin, and
wherein the roof skirt comprises a plurality of indentations for supporting a second apparatus that may be stacked on said roof skirt of a first apparatus.

23. The apparatus of claim 16, wherein the light assembly of the apparatus comprises:
a light housing coupled to the container and extending upwardly into the hollow chamber;
an electrical socket accommodated within the light housing; and
a light source accommodated within the light housing and electrically coupled to the electrical socket, the light source being adapted to illuminate the hollow chamber.

24. The apparatus of claim 16, wherein the apparatus further comprises a first set of tracks mounted on the container and a second set of tracks mounted on the roof assembly, wherein the first set of tracks and the second set of tracks are adapted to receive bottom portions and top portions, respectively, of the plurality of door panels thereon for movably mounting the plurality of door panels between the container and the roof assembly.

25. The apparatus of claim 16, wherein the support assembly of the apparatus comprises:
a plurality of vertical support members supported vertically on the surface; and
a plurality of horizontal support members coupled to the plurality of vertical support members in a manner such that each of the plurality of horizontal support members extends between two vertical support members of the plurality of vertical support members to configure a horizontal support structure for supporting the base of the container thereon, and
wherein the support assembly further comprises a plurality of wheels configured at bottom end portions of the plurality of vertical support members, the plurality of wheels adapted to enable mobility of the apparatus from one place to another.
